(19) United States
(12) Patent Application Publication
(10) Pub. No.: US 2007/0296881 A1
(43) Pub. Date: Dec. 27, 2007

(54) Array substrate for liquid crystal display device

(75) Inventors: Hee-Dong Choi, Seosan-si (KR); Won-Hee Choi, Seoul (KR); Jung-Soo Heo, Chilgok-gun (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/639,505

(22) Filed: Dec. 15, 2006

(30) Foreign Application Priority Data
Jun. 15, 2006 (KR) P2006-0053873

(51) Int. Cl. G02F 1/1333

(52) U.S. Cl. 349/40

(57) ABSTRACT

An array substrate for an LCD device comprises a substrate having a display region and a non-display region at periphery of the display region; a gate line along a first direction on the substrate; first and second data lines along a second direction on the substrate; a ground line along the first direction in the non-display region and dividing the non-display region into first and second regions; a first electrostatic discharge protection circuit in the first region and connected to the first data line; and a second electrostatic discharge protection circuit in the second region and connected to the second data line.

The patent application claims the benefit of Korean Patent Application No. 2006-0053873 filed in Korea on Jun. 15, 2006, which is hereby incorporated by reference.

### BACKGROUND OF THE INVENTION

1. Field of the Invention

The present invention relates to a liquid crystal display (LCD) device and more particularly to an array substrate for an LCD device including an electrostatic discharge (ESD) protection circuit with high resolution.

2. Discussion of the Related Art

A liquid crystal display (LCD) includes a first substrate, a second substrate and a liquid crystal layer. The first and second substrates face each other and are spaced apart from each other with the liquid crystal layer interposed between the first and second substrates. The LCD device uses optical anisotropy and polarization properties of the liquid crystal molecules to display images.

The liquid crystal molecules have a thin and long orientation. Moreover, a direction of the liquid crystal molecule arrangement may be controlled by applying an electrical field to the liquid crystal molecules. The LCD device may include a thin film transistor (TFT) as a switching element. This device is referred to as an active matrix LCD (AM-LCD) device which has excellent resolution and superior moving image display characteristics.

FIG. 1 is an exploded perspective viewing of an LCD device according to the related art.

As shown in FIG. 1, the first and second substrates 12 and 22 face each other, and the liquid crystal layer 30 is interposed between the first and second substrates 12 and 22. The first substrate 12 includes gate lines GL, data lines DL, thin film transistors (TFT) a Tr, and pixel electrodes 18. The gate lines GL and the data lines DL cross each other such that pixel regions P are defined by the gate and data lines GL and DL. The TFTs Tr are formed at respective crossing portions of the gate and data lines GL and DL, and the pixel electrodes 18 are formed in each of the pixel regions P and connected to the corresponding TFTs Tr.

The second substrate 22 includes a black matrix 25, a color filter layer 26, and a common electrode 28. The black matrix 25 has a lattice shape to cover a non-display region of the first substrate 12 that includes the gate lines GL, data lines DL, and the TFTs Tr. The color filter layer 26 includes first, second, and third sub-color filters 26a, 26b, and 26c, respectively. Each of the sub-color filters 26a, 26b, and 26c has one of red, green, and blue colors “R”, “G”, and “B”, and each corresponds to the pixel region P. The common electrode 28 is formed on the black matrix 25 and the color filter layer 26 as well as being formed over an entire surface of the second substrate 22. The arrangement of the liquid crystal molecules is controlled by a vertical electric field between the pixel electrode 18 and the common electrode 28, thereby resulting in a change of the amount of transmitted light. Thus, the LCD device displays images. Accordingly, the LCD device using the vertical electric field has a high transmittance and a high aperture ratio.

However, the fabricating process of the LCD device is very complicated. Moreover, a static electricity is generated during the fabricating process and after finishing of fabricating process. To prevent the TFT being damaged from the static electricity, an electrostatic discharge (ESD) protection circuit is disposed at an end of the data line.

FIG. 2 is a schematic circuit diagram of an array substrate for an LCD device including an ESD protection circuit according to the related art.

As shown in FIG. 2, the gate lines GL and the data line DL cross each other such that the pixel regions P are defined on the substrate 52. The TFTs Tr are formed in each pixel region P. The pixel electrodes PXL are formed in each pixel region P and connected to each TFTs Tr. The ESD protection circuits E are formed at ends of the data lines DL. The ESD protection circuits E extend from a ground line Gdl. The ground line Gdl crosses the data lines DL. In other words, the ground line Gdl may be parallel to the gate line GL.

The ESD protection circuit E prevents the TFT Tr from being damaged by static electricity, which may be generated during the process of fabricating the array substrate. The ESD protection circuit E should not affect the data line when there is no static electricity. To achieve these functions, the ESD protection circuit E includes a plurality of driving elements. The plurality of driving elements may be a plurality of TFTs T1, T2 and T3. In other embodiments, the driving elements may include a plurality of diodes.

The ESD protection circuit E has a same width as the pixel region P. And the ESD protection circuits E, which are connected each of the data lines DL, are arranged along a direction of the ground line Gdl.

Recently, in order to produce high resolution, the pixel region P has become narrower and narrower. Particularly, the width w1 of the pixel region P, that is a distance between the data line DL, has been narrowed. Accordingly, it is difficult to arrange a plurality of ESD protection circuits E along the ground line Gdl.

### SUMMARY

Accordingly, the present invention is directed to a liquid crystal display device that substantially obviates one or more of the problems due to limitations and disadvantages of the related art.

An object of the present invention is to provide an array substrate for a liquid crystal display device including electrostatic discharge protection circuits.

Additional features and advantages of the invention will be set forth in the description which follows, and in part will be apparent from the description, or will be learned by practice of the invention. The objectives and other advantages of the invention will be realized and attained by the structure particularly pointed out in the written description and claims hereof as well as the appended drawings.

An array substrate for an LCD device comprises a substrate having a display region and a non-display region at periphery of the display region. A gate line is disposed along a first direction on the substrate. First and second data lines are disposed along a second direction on the substrate. A ground line is disposed along the first direction in the non-display region and divides the non-display region into first and second regions. A first electrostatic discharge protection circuit is provided in the first region and connected to the first data line. A second electrostatic discharge protection circuit is provided in the second region and connected to the second data line. In another aspect of the present invention, a method of fabricating an array substrate for an LCD device comprises providing a substrate having a display region and a non-display region at periphery of the display region; forming a gate line along a first direction on the substrate; forming first and second data lines along a second direction on the substrate; forming a ground line along the first direction in the non-display region and dividing the non-display region into first and second regions; providing a first electrostatic discharge protection circuit in the first region and connected to the first data line; and providing a second electrostatic discharge protection circuit in the second region and connected to the second data line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an exploded perspective viewing of an LCD device according to the related art.

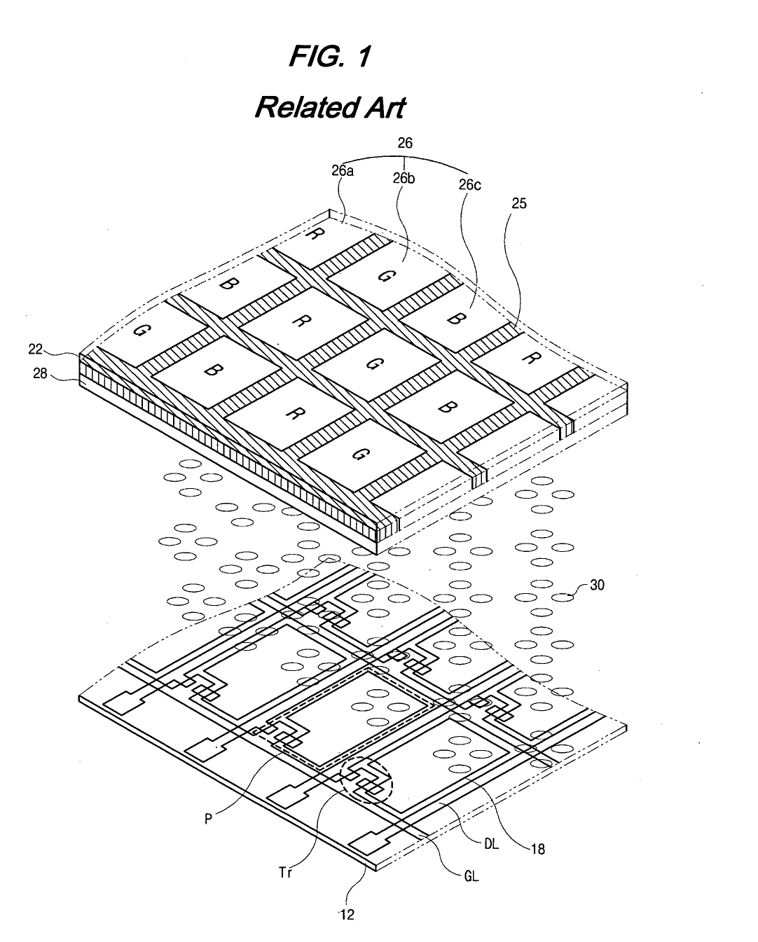

FIG. 2 is a schematic circuit diagram of an array substrate for an LCD device including an ESD protection circuit according to the related art.

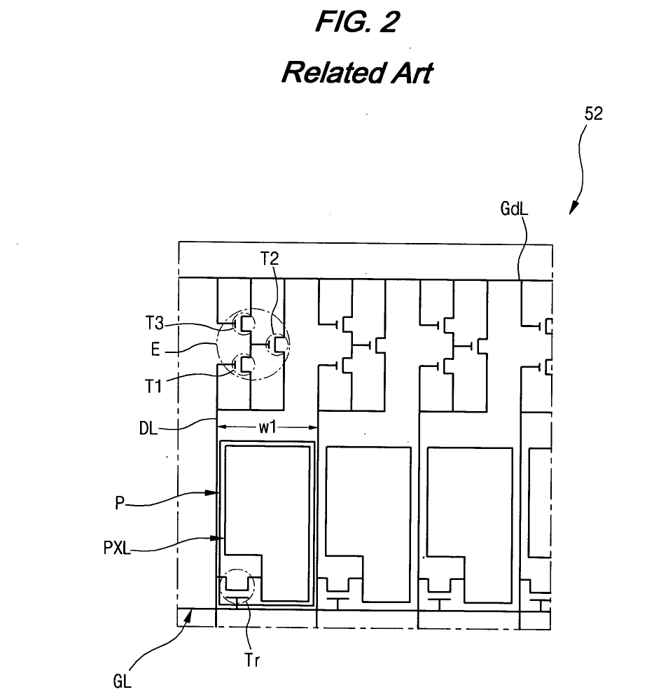

FIG. 3 is a schematic circuit diagram of an array substrate for an LCD device including an ESD protection circuit according to an embodiment of the present invention.

### DETAILED DESCRIPTION OF THE PREFERRED EMBODIMENTS

Reference will now be made in detail to the preferred exemplary embodiments of the present invention, examples of which are shown in the accompanying drawings.

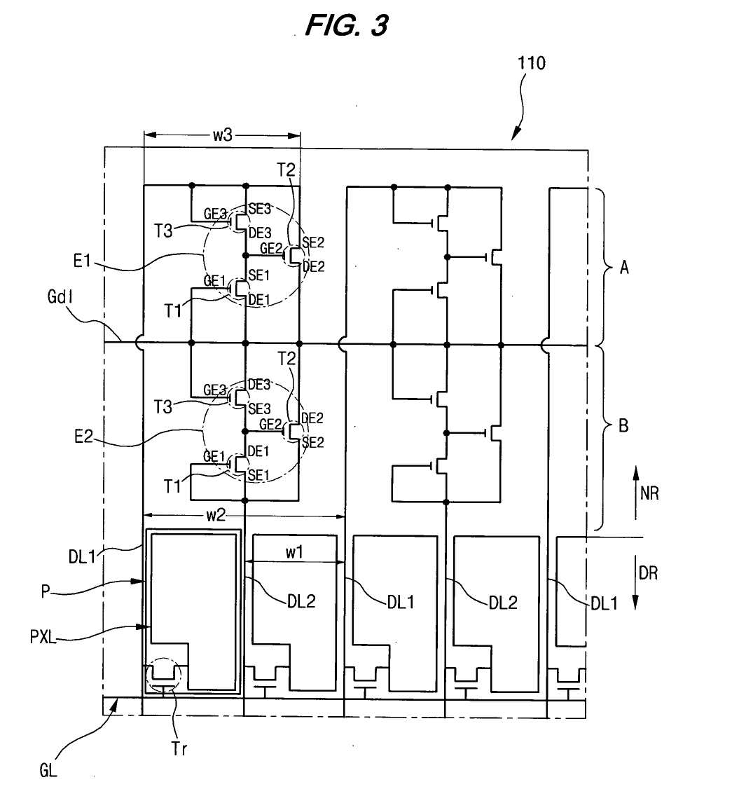

FIG. 3 is a schematic circuit diagram of an array substrate for an LCD device including an ESD protection circuit according to an embodiment of the present invention.

As shown in FIG. 3, displaying and non-display regions DR and NR are defined on the substrate 110. The gate and data lines GL and DL are formed along first and second directions, respectively, on the substrate 110. The gate and data lines GL and DL cross each other such that the pixel region P is defined in the display region DR. The TFT Tr is formed at crossing portion of the gate and data lines GL and DL in each pixel region P. The pixel electrode PXL is formed at each pixel region P and connected to the TFT Tr. The data line DL includes first and second lines DL1 and DL2. The first and second lines DL1 and DL2 are alternately arranged with and parallel to each other. In other words, (2N−1) th data line DL is defined as the first line DL1, and (2N) th data line DL is defined as the second line D2.

The first and second lines DL1 and DL2 extend to the non-display region NR, and first and second ESD protection circuits E1 and E2 are formed in the non-display region NR. The first ESD protection circuit E1 is connected to an end of the first line DL1, and the second ESD protection circuit E2 is connected to an end of the second line DL2. The ground line Gdl is formed along the first direction in a center portion of the non-display region NR. In other words, the ground line Gdl is parallel to the gate line GL, and the non-display region NR is divided into first and second regions A and B by the ground line Gdl. The first region A may be distant from the display region DR, and the second region B may be near to the display region DR.

The first and second ESD protection circuits E1 and E2 are disposed in the first and second regions A and B, respectively. In other words, the first line DL1 is connected to the first ESD protection circuit E1 in the first region A, and the second line DL2 is connected to the second ESD protection circuit E2 in the second region B. However, in another exemplary embodiment, the first line is connected to the second ESD protection circuit in the second region, and the second line is connected to the first ESD protection circuit in the first region.

In the array substrate according to the present invention, the ESD protection circuit may have a width corresponding to two pixel regions P, not only one pixel region as the related art. In more detail, when one pixel region has a first width w1, a region in which the ESD protection circuit is formed, has a second width w2 two times more than the first width w1. In FIG. 3, a third width w3 of the ESD protection circuit E is less than the second width w2. However, the third width w3 may be equal to the second width w2. Accordingly, when the array substrate has less pixel region to produce high resolution, there is substantial room for the ESD protection circuit E.

Next, the ESD protection circuit E is described. Each of the first and second ESD protection circuits E1 and E2 includes first, second and third TFTs T1, T2 and T3.

The first ESD protection circuit E1 in the first region A is connected to the first line DL1 and the ground line Gdl. The first line DL1 crosses the ground line Gdl. The first line DL1 is connected to a third gate electrode GE3 and a third source electrode SE3 of the third TFT T3 and a second source electrode SE2 of the second TFT T2. A third drain electrode DE 3 of the third TFT T3 is connected to a second gate electrode GE2 of the second TFT T2 and a first source electrode SE1 of the first TFT T1. Moreover, a first gate electrode GE1 and a first drain electrode DE1 of the first TFT T1 and a second drain electrode DE2 are connected to the ground line Gdl.

Similarly, the second ESD protection circuit E2 in the second region B is connected to the second line DL2 and the ground line Gdl. The second line DL2 is connected to a first gate electrode GE1 and a first source electrode SE1 of the first TFT T1 and a second source electrode SE2 of the second TFT T2. A first drain electrode DE1 of the first TFT T1 is connected to a second gate electrode GE2 of the second TFT T2 and a third source electrode SE3 of the first TFT T3. Moreover, a third gate electrode GE3 and a third drain electrode DE3 of the first TFT T3 and a second drain electrode DE2 are connected to the ground line Gdl.

When static electricity is generated, a higher voltage than normal voltage is applied into the first and second lines DL1 and DL2. Since the third gate electrode GE3 of the third TFT T3 in the first ESD protection circuit E1 is connected to the first line DL1, the third TFT T3 of the first ESD protection circuit E1 has ON state by an overloading voltage resulted form the static electricity. Moreover, since the second gate electrode GE2 of the second TFT T2 in the first ESD protection circuit E1 is connected to the third drain electrode DE 3, the second TFT T2 of the first ESD protection circuit E1 has ON state. The overloading voltage is applied into the ground line Gdl through the second TFT T2 of the first ESD protection circuit E1. The overloading voltage in the ground line Gdl does not flow backward into the first ESD protection circuit E1 due to the first TFT T1.

The second ESD protection circuit E2 functions like the first ESD protection circuit E1. The first TFT T1 of the second ESD protection circuit E2 corresponds to the third TFT T3 of the first ESD protection circuit E1, and the third TFT T3 of the second ESD protection circuit E2 corresponds to the first TFT T1 of the first ESD protection circuit E1.

When there is no static electricity in the pixel region P, the ESD protection circuit E does not affect the TFT Tr of the pixel region P. Since a substantial voltage is not applied into the first and second lines DL1 and DL2, the third TFT T3 of the first ESD protection circuit E1 and the first TFT T1 of the second ESD protection circuit E2 have an OFF state. Accordingly, the TFT Tr of the pixel region P works without affecting the first and second ESD protection circuits E1 and E2.

When a plurality of TFTs greater than three are used for each ESD protection circuit, the ESD protection circuits are disposed as described above with various modifications and variations.

It will be apparent to those skilled in the art that various modifications and variations can be made in the liquid crystal display device of the present invention without departing from the spirit or scope of the invention. Thus, it is intended that the present invention cover the modifications and variations of this invention provided they come within the scope of the appended claims and their equivalents.

What is claimed is:

1. An array substrate for an LCD device, comprising:
a substrate having a display region and a non-display region at periphery of the display region;
a gate line along a first direction on the substrate;
first and second data lines along a second direction on the substrate;
a ground line along the first direction in the non-display region and dividing the non-display region into first and second regions;
a first electrostatic discharge protection circuit in the first region and connected to the first data line; and
a second electrostatic discharge protection circuit in the second region and connected to the second data line.

2. The substrate according to claim 1, further comprising third data line along the second direction such that first, second and third data lines cross the gate line to define first and second pixel regions, wherein each of the first and second electrostatic discharge protection circuits has a width greater than a width of each pixel region.

3. The substrate according to claim 2, wherein each of the first and second electrostatic discharge protection circuits has a substantially same width as two pixel regions.

4. The substrate according to claim 2, further comprising a third electrostatic discharge protection circuits in one of the first and second regions and connected to the third data line.

5. The substrate according to claim 1, wherein each of the first and second electrostatic discharge protection circuits includes first, second and third transistors.

6. The substrate according to claim 5, wherein each of the first and second data lines is connected to gate and source electrodes of the first transistor and a source electrode of the second transistor, a drain electrode of the first transistor is connected to a gate electrode of the second transistor and a source electrode of the third transistor, and a drain electrode of the second transistor and gate and drain electrodes of the third transistor are connected to the ground line.

7. The substrate according to claim 1, further comprising thin film transistors connected to the gate line and the first and second data lines.

8. The substrate according to claim 7, further comprising pixel electrodes in the display region and connected to the thin film transistors.

9. A method of fabricating an array substrate for an LCD device, comprising:
Providing a substrate having a display region and a non-display region at periphery of the display region;
forming a gate line along a first direction on the substrate;
forming first and second data lines along a second direction on the substrate;
forming a ground line along the first direction in the non-display region and dividing the non-display region into first and second regions;
providing a first electrostatic discharge protection circuit in the first region and connected to the first data line; and
providing a second electrostatic discharge protection circuit in the second region and connected to the second data line.
